(19) United States
(12) Patent Application Publication
(10) Pub. No.: US 2010/0119947 A1
(43) Pub. Date: May 13, 2010

(54) METHOD FOR FORMING CATHODE ACTIVE MATERIAL POWDER FOR LITHIUM SECONDARY CELL, AND CATHODE ACTIVE MATERIAL POWDER FOR LITHIUM SECONDARY CELL PREPARED USING THE METHOD

(75) Inventors: Young-Gi LEE, Daejeon (KR); Kwang Man Kim, Daejeon (KR); Jongdae Kim, Daejeon (KR); Jaephil Cho, Geonggi-do (KR); Sun Hye Lim, Geonggi-do (KR)

Correspondence Address: RABIN & Berdo, PC, 1101 14TH STREET, NW, SUITE 500, WASHINGTON, DC, 20005, US

(73) Assignees: ELECTRONICS AND TELECOMMUNICATIONS RESEARCH INSTITUTE, Daejeon (KR); INDUSTRY-UNIVERSITY COOPERATION FOUNDATION HANYANG UNIVERSITY, Seoul (KR)

(21) Appl. No.: 12/484,707

(22) Filed: Jun. 15, 2009

(30) Foreign Application Priority Data
Nov. 13, 2008 (KR) 10-2008-0112529

(51) Int. Cl. H01M 4/58; H01M 4/88

(52) U.S. Cl. 429/231.95; 502/101

(57) ABSTRACT

Provided are a method for forming a cathode active material powder for a lithium secondary cell, and a cathode active material powder prepared using the method. According to the method, a coating layer consisting of a combination of a water-soluble polymer and a metal oxide may be formed on the particle surface of the cathode active material, thereby forming a uniform thickness of the coating layer. Thus, the elution of manganese may be prevented, thereby improving the capacity of the cathode active material and providing excellent cycle characteristics.

### CROSS-REFERENCE TO RELATED APPLICATIONS

This U.S. non-provisional patent application claims priority under 35 U.S.C. §119 of Korean Patent Application No. 10-2008-0112529, filed on Nov. 13, 2008, the entire contents of which are hereby incorporated by reference.

### BACKGROUND OF THE INVENTION

The present invention disclosed herein relates to a method for forming a cathode active material powder for a lithium secondary cell, and a cathode active material powder for a lithium secondary cell, prepared using the method.

Studies on lithium manganese oxides (LiMn₂O₄) with a spinel structure as a cathode active material for a lithium secondary cell have been actively conducted. However, there are limitations that structural variation may occur at high temperature when a lithium deintercalated Li₀Mn₂O₄ (λ-MnO₂) is reacted with electrolyte. Reaction with electrolyte may cause a material containing manganese ion to be eluted on the surface of a lithium manganese oxide (LiMn₂O₄) electrode, thereby reducing the capacity of a 4 V lithium/lithium manganese oxide (Li/LiₓMn₂O₄) cell. The use of Li₁₊ₓMn₂₋ₓO₄ spinels at 55° C. may prevent a manganese ion from being eluted and lessen capacity reduction, but has the disadvantage of low initial capacity. To minimize the manganese elution of LiMn₂O₄ at temperatures of 50° C. or more to have stable cycle characteristics, it is most important to control the reactivity between electrolyte and spinel surfaces. Thus, a surface coating has been provided as a typical method for minimizing the elution of manganese. However, it is very difficult to form a coating layer with a uniform thickness using the typical coating method, thereby increasing the possibility that manganese may be eluted from thin portions. The smaller the cathode active materials are reduced to (sub-nano meters), the more difficult it is to form a coating layer with a uniform thickness.

### SUMMARY OF THE INVENTION

The present invention provides a method for forming a cathode active material powder for a lithium secondary cell, which may prevent the elution of manganese layers by forming a uniform coating layer on the particle of the cathode active material.

The present invention also provides a cathode active material powder for a lithium secondary cell, which may prevent the elution of manganese layers including a uniform coating layer.

Embodiments of the present invention provide methods for forming a cathode active material for a lithium secondary cell, including dissolving a water-soluble polymer in water; pouring a cathode active material powder in the water, stirring and leaving to coat the particle surface of the cathode active material with the water-soluble polymer; chemically adsorbing metal ions on the particle surface of the cathode active material coated with the water-soluble polymer; filtering and drying the cathode active material particles; and sintering the cathode active material particles to form a coating layer consisting of a combination of the water-soluble polymer and a metal oxide on the particle surface of the cathode active material.

In some embodiments, the coating layer may be formed to have a thickness of from 1 nm to 25 nm.

In other embodiments, the water-soluble polymer may be at least one selected from the group consisting of polyvinyl pyrrolidone (PVP), polyethylene oxide (PEO), carboxymethyl cellulose (CMC), polyvinyl alcohol (PVA), polyetherimide (PEI), or polyvinyl acetate (PVAc).

In still other embodiments, the chemically adsorbing of the metal ions on the particle surface of the cathode active material coated with the water-soluble polymer may include pouring a metal compound in the water and ionizing the compound; and removing ions which do not contain metals ionized from the metal compound.

In other embodiments of the present invention, cathode active material powders include particles of a cathode active material particle with a spinel structure; and a coating layer consisting of a combination of a water-soluble polymer and a metal oxide, which surrounds the particle surface of the cathode active material.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a schematic view sequentially illustrating a method for forming a cathode active material powder for a lithium secondary cell according to one embodiment of the present invention;

FIG. 2 is a SEM photograph of a lithium manganese oxide (LiMn₂O₄) with a spinel structure, used in one Experimental Example of the present invention;

FIG. 3 is a SEM photograph of a lithium manganese oxide (LiMn₂O₄) coated with a PVP−MgO layer prior to sintering, prepared in one Experimental Example of the present invention;

FIG. 4 is a SEM photograph of a lithium manganese oxide (LiMn₂O₄) coated with a PVP−MgO layer after sintering, prepared in one Experimental Example of the present invention;

FIG. 5 is a TEM photograph of a lithium manganese oxide (LiMn₂O₄) coated with a PVP−MgO layer after sintering, prepared in one Experimental Example of the present invention;

FIG. 6 is a line-scan graph illustrating distributions of elements with the depth of a lithium manganese oxide coated with a PVP−MgO layer prepared in one Experimental Example of the present invention;

FIG. 7 is a TEM photograph of a lithium manganese oxide (LiMn₂O₄) coated with a MgO layer prepared in one Experimental Example of the present invention;

FIG. 8 are graphs illustrating each of the charge-discharge results of the cells containing each of the cathode active material particles prepared in Experimental Examples of the present invention;

FIG. 9 is a graph illustrating the cycle characteristics of each of the cells containing each of the cathode active material particles prepared in Experimental Examples of the present invention;

FIG. 10 is a graph illustrating each of the results of XRD analysis after the cycle characteristic experiments of each of the cathode active material particles prepared in Experimental Examples of the present invention; and

FIG. 11 is a TEM photograph of a cathode active material particle prepared in another Experimental Example of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

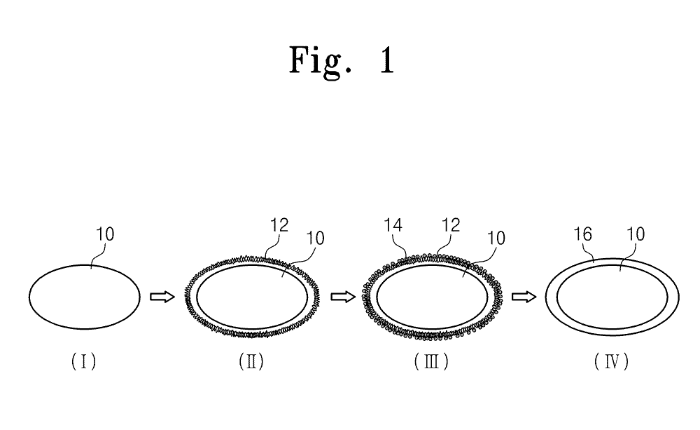

FIG. 1 is a schematic view sequentially illustrating a method for forming a cathode active material powder for a lithium secondary cell according to one embodiment of the present invention.

Referring to FIG. 1, a cathode active material powder is prepared (Step I). The particle 10 of the cathode active material powder may be, for example, a lithium manganese oxide (LiMn₂O₄) with a spinel structure. A water-soluble polymer 12 is poured in distilled water to be dissolved. The water-soluble polymer may be one selected from the group consisting of PVP (polyvinyl pyrrolidone), polyethylene oxide (PEO), carboxymethyl cellulose (CMC), polyvinyl alcohol (PVA), polyetherimide (PEI), or polyvinyl acetate (PVAc). The water-soluble polymer may preferably be added into the distilled water in an amount of 0.1% to 2.5% by weight based on the total weight. When the cathode active material powder is added into the distilled water, stirred and left, the particle 10 surface of the cathode active material is coated with the dissolved water-soluble polymer 12 (Step II). Subsequently, a metal compound, which may be dissociated into a ion, is added into the distilled water. The metal compound may be, for example, MgC₂O₄ or aluminum nitride. The amount of the metal compound added may be regulated such that the weight of the metal oxide to be subsequently formed will be 0.1% to 2.5% based on the total weight of the cathode active material powder. When the metal compound is added into the distilled water, the metal compound is dissociated into a metal ion and an ion which does not contain the metal. That is, when the metal compound is MgC₂O₄, it may be dissociated into Mg²⁺and C₂O₄²⁻. When the metal compound is an aluminum nitride, it may be dissociated into Al³⁺and NO₃⁻. When the metal compound is dissociated, the ion which does not contain the metal is removed with a filter. Thus, only metal ions are left in the distilled water, and the left metal ions 14 are bound to the backbone structure of the water-soluble polymer 12 (Step III). That is, metal ions 14 are chemically adsorbed on the particle 10 surface of the cathode active material coated with the water-soluble polymer 12 in the step. Subsequently, the cathode active material powder is filtered and dried, after which it is sintered. The sintering process may be performed, for example, at about 600° C. for 3 hours. Through the sintering process, the excess water-soluble polymers which are left uncoated on the particle 10 surface of the cathode active material are burnt and removed, oxygen is bound to the metal atom to form a metal oxide, and a coating layer 16, (in which the metal oxide and the water-soluble polymer are bound) is formed IV. The coating layer is formed to have a thickness of, preferably, from 1 nm to 25 nm. When the coating layer is thinner than 1 nm, it is so thin that it is hard to prevent the elution of manganese contained in the cathode active material. When the coating layer is thicker than 25 nm, it is so thick that it is difficult for lithium ions in the cathode active material to move externally.

### EXPERIMENTAL EXAMPLE 1

### Formation of MgO+PVP Coating Layer

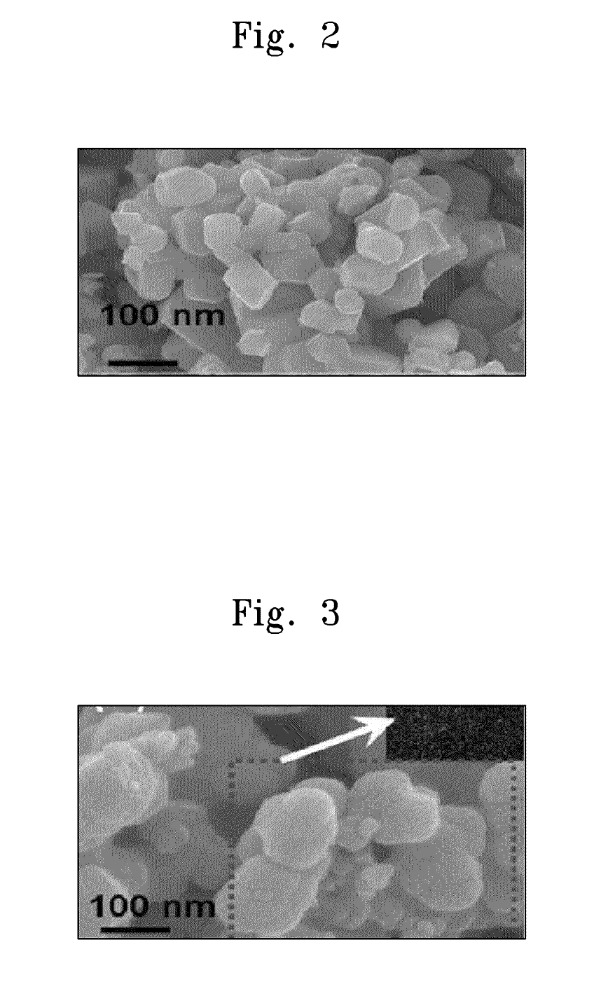

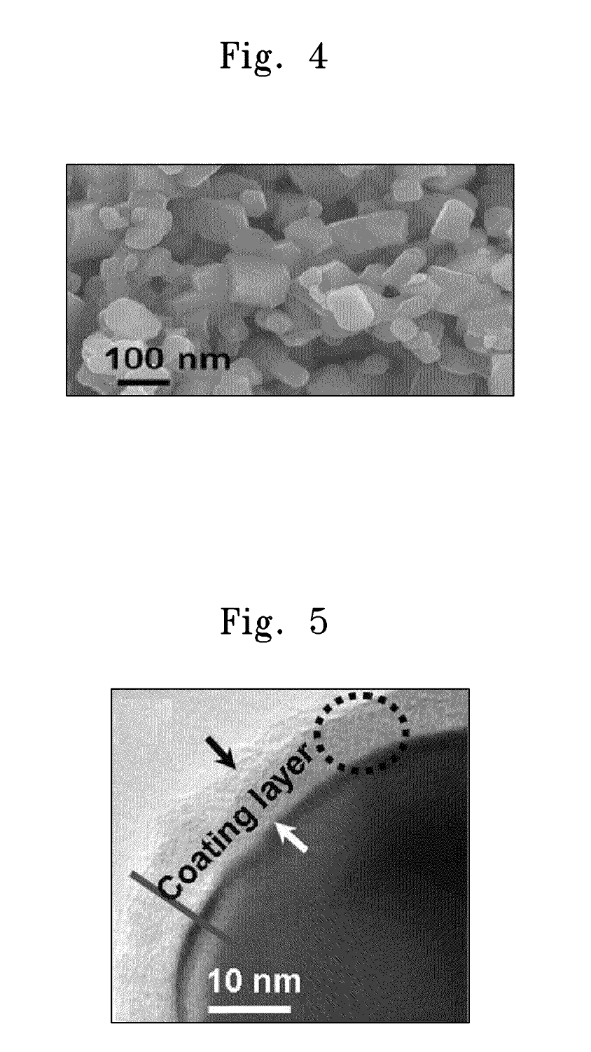

An experiment was conducted to form a coating layer in which PVP (polyvinyl pyrrolidone)-MgO are bound to a nano-scale lithium manganese oxide (LiMn₂O₄) powder with a spinel structure, which is one of the cathode active materials. Specifically, PVP was dissolved in distilled water, and then a lithium manganese oxide powder was poured in the distilled water and stirred. A SEM (Scanning Electron Microscopy) photograph of lithium manganese oxide powders before being dissolved in the distilled water is shown in FIG. 2. Referring to FIG. 2, it can be confirmed that the particle surface of the lithium manganese oxide was smooth. The PVP was added in an amount of 1% by weight based on the total weight of the lithium manganese oxide powder. The distilled water containing the powder was left still at about 40° C. for 10 minutes. MgC₂O₄ was added to form a metal oxide coating. The amount of the MgC₂O₄ added was regulated such that the weight of MgO to be subsequently formed would be 0.1% by weight based on the total weight of the lithium manganese oxide powder. C₂O₄²⁻ dissolved in the distilled water was removed with a filter. Subsequently, the lithium manganese oxide powder was filtered and dried. A SEM photograph of lithium manganese oxide powders in this state is shown in FIG. 3. Referring to FIG. 3, it can be noted that the particle surface of the lithium manganese oxide powder was not smooth, but embossed due to the adsorption of magnesium ions. After the filtering and drying process, a sintering process was conducted. The sintering process was performed at about 600° C. for 3 hours, and through the sintering process, the excess PVP was all burnt and removed to form a MgO+PVP coating layer in which MgO and PVP were bound to the particle surface of the lithium manganese oxide powder. SEM and TEM (transmission electron microscopy) photographs of the lithium manganese oxide powder at this point are shown respectively in FIG. 4 and FIG. 5. Referring to FIG. 4, it can be noted that the particle surface of the lithium manganese oxide powder became smooth again as in FIG. 2. Referring to FIG. 5, it can be recognized that a coating layer with a uniform thickness of about 10 nm was formed on the particle of the lithium manganese oxide powder with a spinel structure.

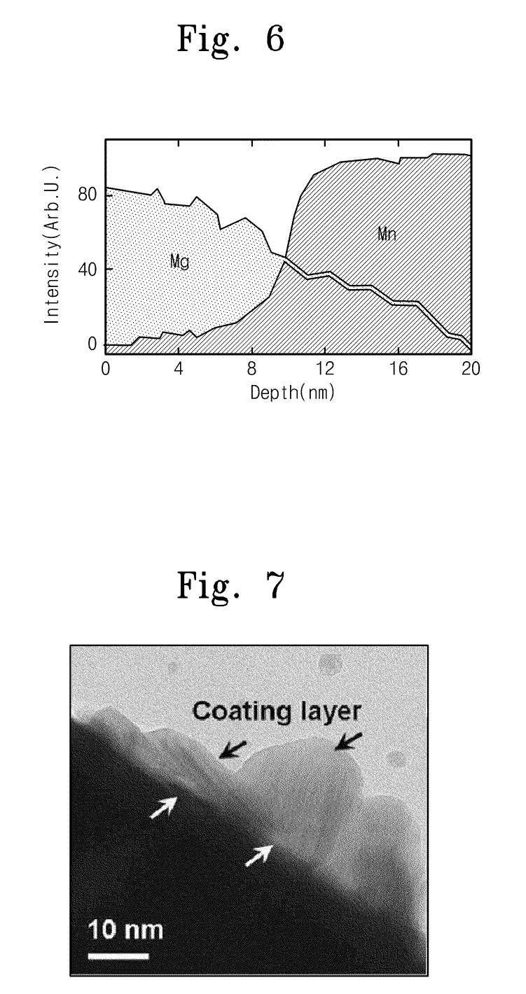

The distributions of elements with the depth of the particle surface of the lithium manganese oxide powder coated with the MgO+PVP coating layer were examined by a line-scan method and the result is shown in the graph in FIG. 6. Referring to FIG. 6, a relatively large amount of magnesium was distributed in the coating layer and a relatively large amount of manganese was distributed in the particle of the lithium manganese oxide. However, it can be noted that the manganese and magnesium were diffused together in the coating layer and the particle, respectively, to provide a conductive passage through which lithium ions may move when a cell is later operated.

### EXPERIMENTAL EXAMPLE 2

### Formation of MgO Coating Layer

An experiment was conducted to form a coating layer in which MgO is bound to a nano-scale powder of the lithium manganese oxide (LiMn₂O₄) with a spinel structure, which is one of the cathode active materials. Specifically, a lithium manganese oxide powder and MgC₂O₄ were poured in the distilled water and stirred. The amount of the MgC₂O₄ added was regulated such that the weight of MgO to be subsequently formed would be 1% by weight based on the total weight of the lithium manganese oxide powder. C₂O₄²⁻ dissolved in the distilled water was removed with a filter. Subsequently, the lithium manganese oxide powder was filtered and dried. After the filtering and drying process, a sintering process was conducted. The sintering process was performed at about 600° C. for 3 hours and through the sintering process, a MgO coating layer was formed on the lithium manganese oxide particle surface.

A TEM (transmission electron microscopy) photograph of the lithium manganese oxide powder at this point is shown in FIG. 7. Referring to FIG. 7, it can be confirmed that a MgO coating layer with a very irregular thickness distribution was formed.

Comparing FIG. 5 with FIG. 7, it can be recognized that the PVP−MgO coating layer has a very uniform thickness, compared to the coating layer containing only MgO. This may be attributed to the fact that PVP uniformly attaches Mg²⁺ ions to the backbone structure of a polymer chain.

### EXPERIMENTAL EXAMPLE 3

### Preparation of Al₂O₃+PVP Coating Layer

An experiment was conducted to form a coating layer in which Al₂O₃+PVP is bound to a nano-scale powder of the lithium manganese oxide (LiMn₂O₄) with a spinel structure, which is one of the cathode active materials. Specifically, PVP was dissolved in distilled water, and then a lithium manganese oxide powder was poured in the distilled water and stirred. The PVP was added in an amount of 1% by weight based on the total weight of the lithium manganese oxide powder. The distilled water containing the powder was left still at about 40° C. for 10 minutes. Al(NO₃)₃ was added to form a metal oxide coating. The amount of the Al(NO₃)₃ added was regulated such that the weight of Al(NO₃)₃ to be subsequently formed would be 1% by weight based on the total weight of the lithium manganese oxide powder. NO₃⁻ dissolved in the distilled water was removed with a filter. Subsequently, the lithium manganese oxide powder was filtered and dried.

### EXPERIMENTAL EXAMPLE 4

### Manufacture of a Cell

Each of the lithium manganese oxide powder prior to the coating process in Experimental Example 1, the lithium manganese oxide powder coated with the MgO+PVP coating layer prepared in Experimental Example 1, the lithium manganese oxide powder coated with the MgO coating layer prepared in Experimental Example 2, and the lithium manganese oxide powder coated with the Al₂O₃+PVP coating layer prepared in Experimental Example 3 were used respectively to manufacture cells. Specifically, polyvinylidene fluoride (PVDF, KF1100, Kureha Chemical Industry Co., Ltd., Japan) binder, Super P carbon black, and an N-methylpyrrolidone (NMP) solution were mixed with each of the powders to form a mixture, and the mixture was coated on aluminum foil to prepare electrode plates. The electrode plates were used as cathodes, and Li metal was used as the anodes to prepare 2016-type coin cells. Ethylene carbonate (EC) in which 1.03 M LiPF₆ was dissolved, diethylene carbonate (DEC), and ethylmethyl carbonate (EMC) were mixed in a volume ratio of 3:3:4 to form an mixed solution.

Charge/discharge experiments were performed between 3 V and 4.5 V on each of the cells including each of the lithium manganese oxide powders.

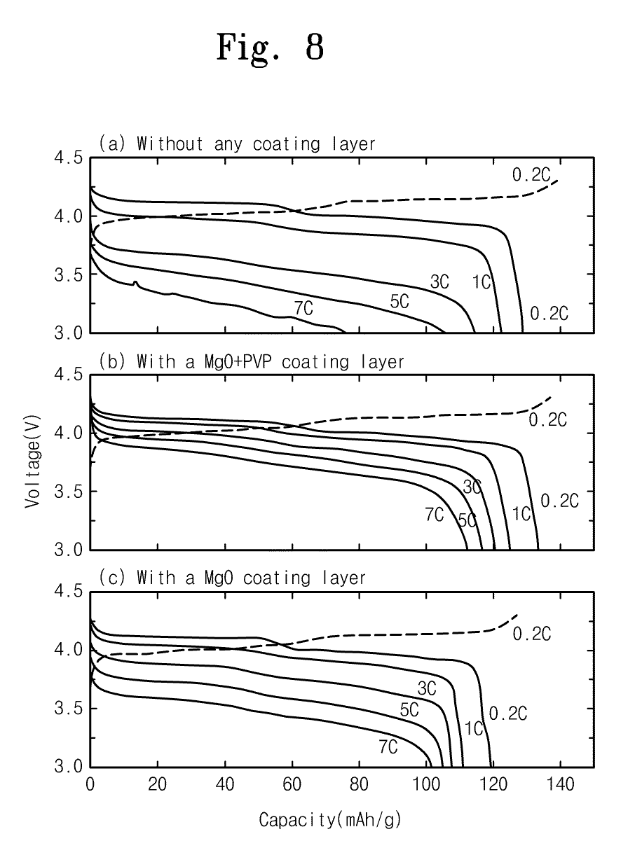

FIG. 8 are graphs illustrating each of the charge-discharge results of the cells containing each of the cathode active material powders prepared in Experimental Examples of the present invention.

Referring to FIG. 8, each of the 0.2 C, 1 C, 3 C, 5 C, and 7 C graphs drawn with solid lines in graphs (a) through (c) shows each of the voltage vs. capacity plots according to a first cycle when a cell is respectively discharged 0.2, 1, 3, 5, and 7 times for an hour. The 0.2 C graphs drawn with dotted lines represent voltage vs. capacity plots according to a first cycle when a cell is charged 0.2 time for 1 hour. The fact that charge or discharge is performed 0.2 time for 1 hour means that charge or discharge is performed 1 time for 5 hours.

The graph (a) in FIG. 8 represents a voltage vs. capacity plot according to a first cycle of charge or discharge of a cell containing the lithium manganese oxide powder without any coating layer, at 65° C. Referring to graph (a), charge and discharge capacities at 0.2 C were 138 mAh/g and 129 mAh/g, respectively, and the irreversible efficiency was 93%. The discharge capacities at 1 C, 3 C, 5 C, and 7 C were 117, 114, 105, and 78 mAh/g, respectively. The capacity retention ratio at 7 C represented 66% of 1 C.

The graph (b) in FIG. 8 represents a voltage vs. capacity plot according to a first cycle of charge or discharge of a cell containing the lithium manganese oxide powder coated with the MgO+PVP coating layer prepared in Experimental Example 1, at 65° C. Referring to graph (b), charge and discharge capacities at 0.2 C were 137 mAh/g and 129 mAh/g, respectively. The irreversible efficiency was 98%, and a 5% improvement was achieved when compared to the case in graph (a) without any coating layer. The discharge capacities at 1 C, 3 C, 5 C, and 7 C were 129, 125, 121, and 112 mAh/g, respectively. The capacity retention ratio at 7 C was 92%, and a 26% improvement was achieved when compared to the case in graph (a) without any coating layer.

The graph (c) in FIG. 8 represents a voltage vs. capacity plot according to a first cycle of charge or discharge of a cell containing the lithium manganese oxide powder coated with the MgO coating layer formed in an amount of 1% by weight without any PVP prepared in Experimental Example 2, at 65° C. Referring to graph (c), the discharge capacity at 0.2 C was reduced to 119 mAh/g. As the C-rate increases, the drop in initial voltage increases more than in graph (b). This may be attributed to the fact that because the coating layer failed to be uniformly formed, the spinel structure was deteriorated more than the case in which the PVP−MgO coating layer was formed.

The initial voltage and discharge capacity at 7 C in graph (b) were 4.1V and 112 mAh/g, respectively, and the initial voltage and discharge capacity at 7 C in graph (c) were 3.8V and 102 mAh/g, respectively. The values were generally lower than those in graph (b).

Thus, it can be noted through the graphs in FIG. 8 that the capacity may be improved by forming a PVP−MgO coating layer of the present invention on the particle surface of the cathode active material.

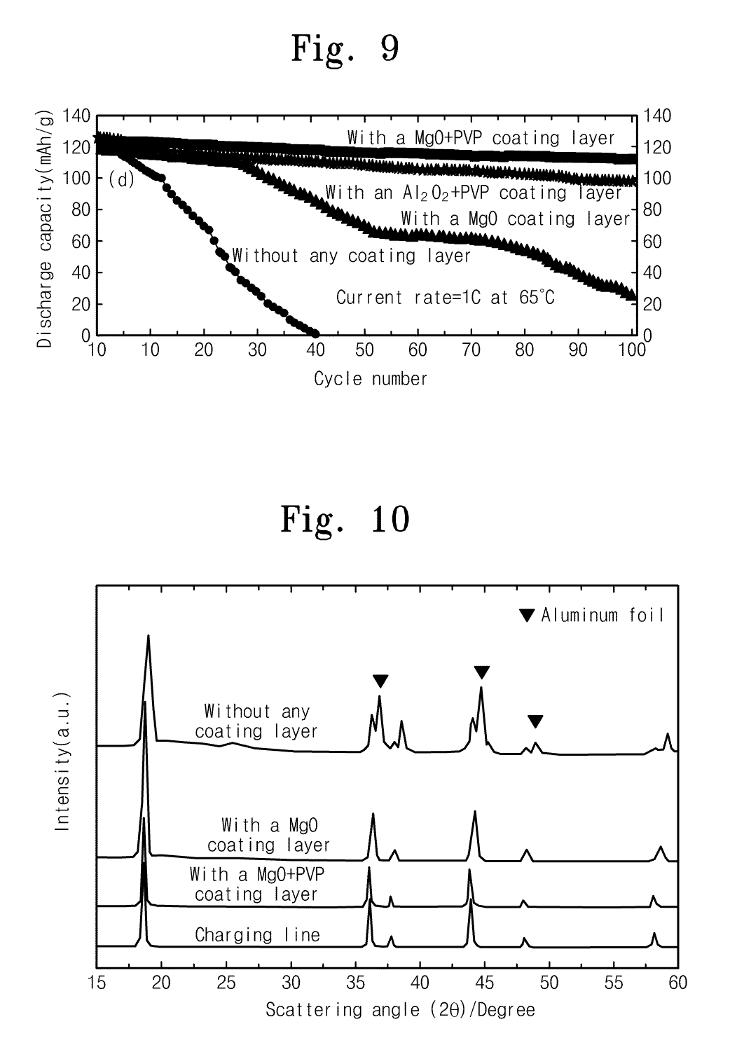

Experiments to test cycle characteristics at from 3V to 5V were performed using each of the cells including each of the lithium manganese oxide powders. The results are shown in the graph in FIG. 9.

FIG. 9 is a graph illustrating the results of the cycle characteristics of each of the cells containing each of the cathode active material particles prepared in Experimental Examples of the present invention. In the graph in FIG. 9, one cycle means one-time charge and discharge.

Referring to FIG. 9, the capacity retention ratio of the cell containing a cathode active material without any coating layer was near 0 after 35 cycles. The capacity retention ratios after 35 cycles are about 95% and 90%, respectively, when the MgO+PVP coating layer was formed and the Al₂O₃ coating layer was formed. The capacity retention ratio in the MgO+PVP coating layer was higher than that in the Al₂O₃+PVP coating layer. This may be attributed to the fact that the MgO+PVP coating layer is denser and more uniform than the Al₂O₃+PVP coating layer. When a coating layer containing only MgO without any PVP was formed, a capacity reduction similar to that in the MgO+PVP coating layer was shown until 30 cycles, but the capacity retention ratio became 10% at 100 cycles, showing a large capacity reduction.

Thus, it can be recognized through the graph in FIG. 9 that the cycle characteristics may be improved by forming a PVP−MgO coating layer of the present invention on the particle surface of the cathode active material.

FIG. 10 is a graph illustrating each of the results of XRD (X-ray Diffraction) analysis by scraping a cathode active material powder from the cell in order to understand a structural variation of the cathode active material included in each of the cells after the cycle characteristic experiments in FIG. 9.

Referring to FIG. 10, the peak of a cathode active material without any coating layer was shifted to the right and a structural damage may be inferred from a widened peak distribution. When an XRD graph for the MgO+PVP coating layer formed is recorded prior to charging, it is the most similar to an XRD graph of the cathode active material before the charge/discharge experiment was conducted. Thus, it can be recognized that the least structural damage in cathode active material occurs when a MgO+PVP coating layer is formed.

### EXPERIMENTAL EXAMPLE 5

### Formation of MgO+PVP Coating Layer with a 2-Fold Thickness

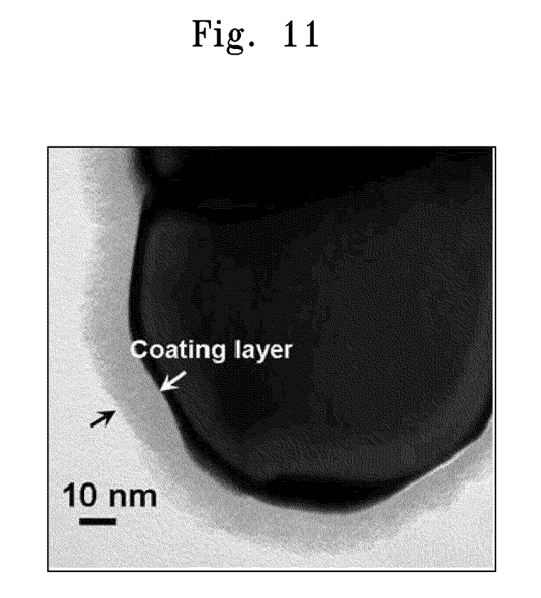

The amount of PVP and MgC₂O₄ added in the present Experimental Example was doubled from that in Experimental Example 1 to form a MgO+PVP coating layer. The other processes were performed in the same way as in Experimental Example 1. A TEM photograph of the MgO+PVP coating layer prepared in the present Experimental Example was illustrated in FIG. 11. Referring to FIG. 11, it can be noted that a uniform coating layer with a thickness of about 20 nm was formed.

It can be recognized through the present Experimental Example that when the content of PVP and metal oxide is doubled, the thickness of the coating layer is doubled. However, when the amount of metal oxide was only doubled without increasing the amount of PVP in another experiment, the thickness of the coating layer was not increased. It is assumed that all of the metal oxides do not bind to the backbone of a PVP polymer, but only a metal oxide which is selectively chemically adsorbed on PVP forms a coating. Thus, extra metal oxides which failed to participate in selective adsorption did not contribute to the increase in coating thickness.

The coating layer is preferably formed to have a thickness of from 1 nm to 25 nm. When the coating layer is thinner than 1 nm, it is so thin that it is hard to prevent the elution of manganese contained in the cathode active material. When the coating layer is thicker than 25 nm, it is so thick that it is difficult for lithium ions in the cathode active material to move externally.

According to a method for forming a cathode active material powder 20 for a lithium secondary cell in the present embodiment, a coating layer consisting of a combination of a water-soluble polymer and a metal oxide may be formed, thereby obtaining a uniform thickness of the coating layer. Thus, the elution of manganese may be prevented, thereby improving the capacity of the cathode active material and providing excellent cycle characteristics.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method for forming a cathode active material powder for a lithium secondary cell, the method comprising:
dissolving a water-soluble polymer in water;
pouring a cathode active material powder in the water, stirring and leaving to coat the particle surface of the cathode active material with the water-soluble polymer;
chemically adsorbing metal ions on the particle surface of the cathode active material coated with the water-soluble polymer;
filtering and drying the cathode active material particles; and
sintering the cathode active material particles to form a coating layer consisting of a combination of the water-soluble polymer and a metal oxide on the particle surface of the cathode active material.

2. The method of claim 1, wherein the coating layer is formed to have a thickness ranging from 1 nm to 25 nm.

3. The method of claim 1, wherein the water-soluble polymer is at least one selected from the group consisting of polyvinyl pyrrolidone (PVP), polyethylene oxide (PEO), carboxymethyl cellulose (CMC), polyvinyl alcohol (PVA), polyetherimide (PEI), or polyvinyl acetate (PVAc).

4. The method of claim 1, wherein the chemically adsorbing of the metal ions on the particle surface of the cathode active material coated with the water-soluble polymer comprises:
pouring a metal compound in the water and ionizing the compound; and
removing ions which do not contain metals ionized from the metal compound.

5. A cathode active material powder for a lithium secondary cell; comprising:
particles of a cathode active material with a spinel structure; and
a coating layer comprising a combination of a water-soluble polymer and a metal oxide, which surrounds the particle surface of the cathode active material.

6. The powder of claim 5, wherein the coating layer has a thickness ranging from 1 nm to 25 nm.

7. The powder of claim 5, wherein the water-soluble polymer is at least one selected from the group consisting of polyvinyl pyrrolidone (PVP), polyethylene oxide (PEO), carboxymethyl cellulose (CMC), polyvinyl alcohol (PVA), polyetherimide (PEI), or polyvinyl acetate (PVAc).
